(19) United States
(12) Patent Application Publication
(10) Pub. No.: US 2022/0234087 A1
(43) Pub. Date: Jul. 28, 2022

(54) METHOD FOR IMPROVING THE EFFICIENCY OF ELECTROKINETIC TECHNOLOGY FOR REMOVING POLLUTANTS FROM SOLID MATRIX BY USING A MIXED MICROBIAL SOLUTION

(71) Applicant: MING CHI UNIVERSITY OF TECHNOLOGY, NEW TAIPEI CITY (TW)

(72) Inventor: Lo TSUI, NEW TAIPEI CITY (TW)

(21) Appl. No.: 17/208,002

(22) Filed: Mar. 22, 2021

(30) Foreign Application Priority Data
Jan. 25, 2021 (CN) 202110096969.3

(51) Int. Cl. B09C 1/10; B09C 1/08

(52) U.S. Cl. CPC B09C 1/105; B09C 1/085

(57) ABSTRACT

A method for removing pollutants by using a mixed microbial solution of beneficial microorganisms to enhance electrokinetic force. It includes a mixed microbial solution; an anode tank and a cathode tank are connected to an external power supply. A soil tank contains contaminant soil and the soil tank is positioned between the anode tank and the cathode tank which are parallel to each other. A soil-retaining net is disposed over the soil. The external direct current is used to allow the mixed microbial solution to transfer in the soil tank.

### CROSS-REFERENCE TO RELATED APPLICATIONS

This non-provisional application claims priority under 35 U.S.C. § 119(a) on Patent Application No(s). 202110096969.3 filed in China on Jan. 25, 2021, the entire contents of which are hereby incorporated by reference.

### BACKGROUND OF THE INVENTION

### Field of the Invention

The present invention relates to methods for improving electrokinetic removal of pollutants using a mixed microbial solution of beneficial microorganisms, and the electrokinetic treatment technology (Electrokinetic Remediation, EK) can directly remove pollutants by in-situ method at the contaminated site, or can also be used as an ex-situ remediation method.

### Description of the Related Art

Currently, due to the development of industry, the rapid increase in population, and the massive investment in industrial and agricultural production, major and secondary rivers in various regions have suffered different levels of mild, moderate, and severe pollution in up to 33% of the total length of the river. Consequently, it will cause the deterioration of groundwater and environmental quality, and even the water quality of agricultural irrigation water in some areas, often resulting in pollution of farmland soil and deterioration of soil quality.

Heavy metal pollution in farmland soil may have a negative impact on human health through the food chain, so soil heavy metal remediation technology has received increasing attention from advanced countries throughout the world. However, in the past, soil heavy metal remediation methods were mostly based on the overturning dilution method, which could only dilute the heavy metals in the soil to meet the regulation standards, but could not actually remove the pollutants from the polluted site. In addition, if the concentration of heavy metals in the soil is too high, it is not suitable to be treated only by the overturning dilution method, and more active remediation techniques are required to remove the heavy metals from soil. Common soil heavy metal removal technologies include soil washing method, phytoremediation method, and electrokinetic method, and these technologies usually require the selection of suitable cleaning agents to improve the removal efficiency of soil heavy metals. However, the commonly used chemical cleaning agents are not only expensive, some chemical agents such as EDTA may also cause environmental damage, so many studies actively tested different natural cleaning agents to evaluate the feasibility of replacing chemical cleaning agents.

Among the above mentioned soil heavy metal remediation technologies, the soil washing method has a good removal effect on high-concentration contaminated soil but the cost of off-ground chemical treatment is relatively large, and a large number of chemicals and acids are used. The phytoremediation method is considered to be the most economical remediation technology, but the required remediation time usually takes decades and it takes a long time to see satisfactory results. The electrokinetic method has been proven to be an effective and relatively low-cost soil remediation technology, especially for the treatment of pollutants in fine particle soil. In addition to heavy metals, electrokinetic method also can be used to treat organic pollutants and different nutrient sources. However, the electrokinetic method to treat soil pollution will still be subject to many restrictions in on-site applications, including: (1) soil heterogeneity, resulting in inconsistent treatment effects; (2) the pH value of some soils may not be conducive to the efficiency of electrokinetic treatment; (3) if the conductivity of the soil solution is low, the electroosmotic flow rate is relatively low, which easily hinders the formation of acid fronts, leading to a long electrokinetic force treatment time; (4) the extra electrolyte is easy to escape due to evaporation.

The current considerations for soil remediation include whether the concentration of heavy metals in the soil can be reduced by technology to a safe concentration in the original agricultural land. The common soil cleaning method is only to dilute the heavy metal pollutants in the soil. It cannot really remove heavy metal pollutants from the soil. Moreover, if the soil is clay soil, the interaction between heavy metals and soil particles is very strong, and it is not difficult to remove heavy metal pollution from the soil by cleaning on-site.

It can be seen that there are still many deficiencies in the above-mentioned conventional methods, which are not well designed and need to be urgently improved.

Therefore, how to achieve real soil remediation and improve the concentration level of heavy metals in the soil, and restore the soil to the original farmland soil farming standards, is still a problem that needs to be overcome and solved.

### BRIEF SUMMARY OF THE INVENTION

In view of this, the main purpose of the present invention is an economical and effective soil restoration technology, especially for low-permeability clay soils that can also have a good remediation effect, which lies in the remediation of existing heavy metal contaminated soil, and uses mixed microbial solution with acidity capacity to match the electrokinetic (EK) remediation technology as a relatively novel in-situ remediation technology, which can be directly remediated on the contaminated site to remove contaminants.

In order to achieve the above purpose, beneficial mixed microorganisms are used to efficiently clean the heavy metals in the soil, and the beneficial mixed microorganisms can be used to maintain the pH of the soil solution at about 3.6, and has characteristics close to the heavy metal chelating agents. In addition, the conductivity of the undiluted beneficial mixed bacteria is 7.0 ms/m. The conductivity of normal water is about 0.2 ms/m. This clearly shows that the beneficial mixed microorganisms can be used as a good electrolyte and at the same time, it is beneficial to the ion movement of the soil solution in the electrokinetic method to remove heavy metal pollution. The surface tension of beneficial mixed microorganisms is 50.3 dyn/cm, which is much smaller than that of water 72.7 dyn/cm. The lower surface tension value could help the beneficial microbial solution penetrate more deeply into the soil pore structure, and hence enhance the heavy metal removal efficiency.

A method of using a mixture of beneficial microorganisms to enhance electrokinetic force to remove pollutants includes:

Step 1. Collect the air-dried soil, and remove the debris; Step 2. Grind the soil with a retaining net with a unit of 10 meshes and put it in a container and place it in a cool place;

Step 3. Using a reaction tank composed of an anode tank, a soil tank, and a cathode tank, put the soil in the soil tank. Place a porous soil retaining plate made of PVC material between the soil tank, the anode tank, and the cathode tank, and fix the soil in the soil tank with a non-woven filter screen;

Step 4. Guide the operating fluid with the beneficial mixed microbial solution into the soil tank with the soil, so that the soil can be immersed in the operating fluid;

Step 5. After immersing for a fixed period of time, export the original operating fluid to the anode tank and the cathode tank, and make the liquid level of the operating fluid higher than the soil height of the soil tank;

Step 6. A porous iridium titanium oxide electrode is set as an anode in the anode tank, and a stainless steel electrode is set as a cathode in the cathode tank;

Step 7. Apply a 1 V/cm electric field to the anode and cathode respectively;

Step 8. The concentration of heavy metal components in the soil can be gradually reduced, and after 7 days of electrokinetic operation, the heavy metal components in the soil can be significantly reduced to nearly complete removal.

In an embodiment of the present invention, the beneficial mixed microbial solution has a pH of 3.8, a conductivity of 7.6 mS/m, and a surface tension of 50.3 dyn/cm.

A device that uses a mixture of beneficial microorganisms to enhance electrokinetic force to remove pollutants is a reaction tank, which includes an operating fluid, which is a beneficial mixed microbial solution composed of fermentation broth of phosphorus solubilizing bacteria, photosynthetic bacteria (Photosynthetic Bacteria, PSB), yeast, and lactic acid bacteria; The two electrode tanks are an anode tank and a cathode tank, and are respectively arranged at the corresponding two ends of the soil tank and arranged horizontally with each other. The operating fluid is introduced into it; the soil tank is loaded with soil with heavy metal pollutants, and a soil retaining net is installed at the connection between the anode tank and the cathode tank to prevent the soil from being introduced into the anode tank and the cathode tank. An operating fluid is allowed to flow so that the soil is immersed in the operating fluid.

In an embodiment of the present invention, the anode tank and the cathode tank are each electrically connected to an external DC power supply.

In an embodiment of the present invention, when the operating fluid is introduced into the anode tank and the cathode tank, its height needs to be higher than the height of the soil tank, so that the soil can be completely immersed in the operating fluid.

In one embodiment of the present invention, the heavy pollutant soil contains heavy metals, sludge, river sediment, or cadmium, copper, nickel, chromium, zinc, lead, mercury, and arsenic, or pollutants in the bottom ash of an incinerator.

In an embodiment of the present invention, the anode tank is provided with a porous iridium titanium oxide electrode as the anode.

In an embodiment of the present invention, the cathode tank is provided with a stainless steel electrode as a cathode.

### BRIEF DESCRIPTION OF THE DRAWINGS

FIG. 1 is a flowchart of the method and equipment for improving electrokinetic force to remove pollutants by using a mixture of beneficial microorganisms of the present invention.

FIG. 2 is a structural diagram of the method and equipment for improving the electrokinetic force to remove pollutants by using the mixed microbial solution of beneficial microorganisms according to the present invention.

FIG. 3 is a graph showing the time change of the pH value of the method and equipment for improving the electrokinetic force to remove pollutants by using the mixed microbial solution of beneficial microorganisms according to the present invention.

FIG. 4 is a soil concentration diagram of the method and equipment for improving the electrokinetic force to remove pollutants by using a mixture of beneficial microorganisms in the present invention.

### DETAILED DESCRIPTION OF THE INVENTION

In order to help understand the technical features, content and advantages of the present invention and the effects that can be achieved, the present invention is described in detail in the form of embodiments with accompanying drawings as follows, and the figures used therein are only for illustrative and auxiliary manual purposes, and may not limit the scope and precise configuration of the invention. Therefore, the configuration relationship of the attached drawings should not be interpreted or limited to the actual implementation of the invention and the scope of the invention.

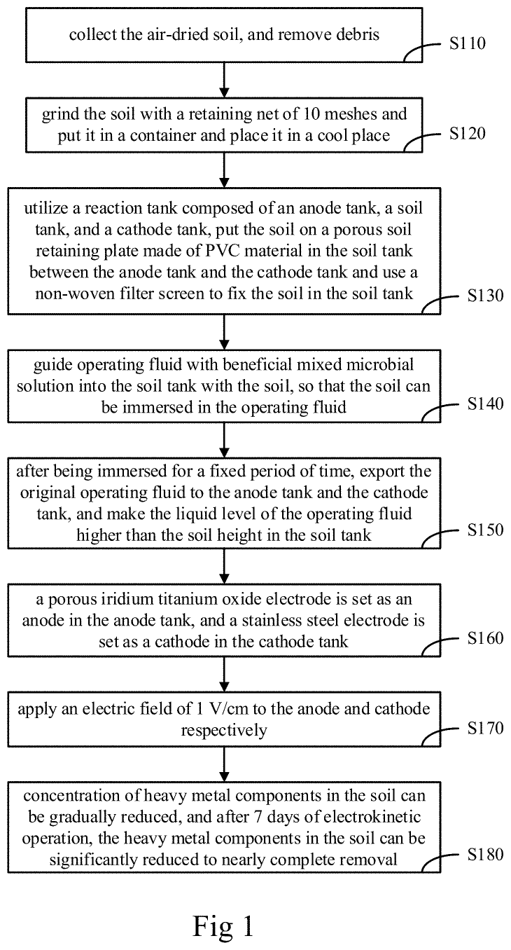

Please refer to FIG. 1, which is a flowchart of a method of using a mixture of beneficial microorganisms to enhance electrokinetic force to remove pollutants according to the present invention, which includes:

Step 1. (S110) Collect the air-dried soil, and remove the debris;

Step 2. (S120) Grind the soil with a retaining net 10 with meshes and put it in a container and place it in a cool place;

Step 3. (S130) Utilize a reaction tank composed of an anode tank, a soil tank, and a cathode tank, put the soil in the soil tank and place it on a porous soil retaining plate made of PVC material situated between the soil tank, anode tank, and the cathode tank. Utilize a non-woven filter screen to fix the soil in the soil tank;

Step 4. (S140) Guide the operating fluid with the beneficial mixed microbial solution into the soil tank with the soil, so that the soil can be immersed in the operating fluid;

Step 5. (S150) After being immersed for a fixed period of time, export the original operating fluid to the anode tank and the cathode tank, and make the liquid level of the operating fluid higher than the soil height of the soil tank;

Step 6. (S160) A porous iridium titanium oxide electrode is set as an anode in the anode tank, and a stainless steel electrode is set as a cathode in the cathode tank;

Step 7. (S170) Apply an electric field of 1 V/cm to the anode and cathode respectively;

Step 8. (S180) The concentration of heavy metal components in the soil can be gradually reduced, and after 7 days of electrokinetic operation, the heavy metal components in the soil can be significantly reduced to nearly complete removal.

The beneficial mixed microbial solution has a pH of 3.8, a conductivity of 7.6 mS/m, and a surface tension of 50.3 dyn/cm.

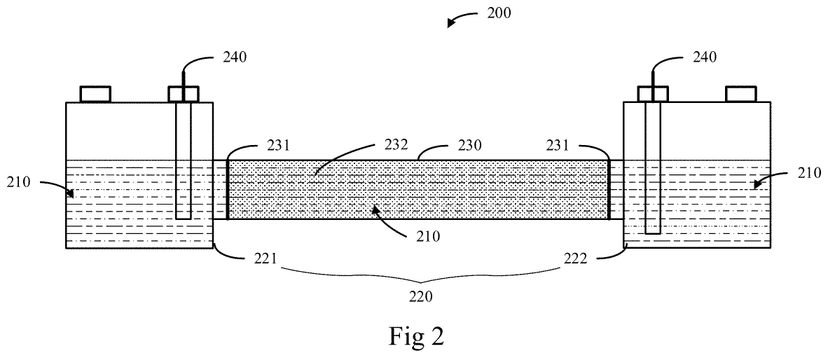

Please refer to FIG. 2, the structure diagram of the method and equipment for removing pollutants by using a mixture of beneficial microorganisms to enhance electrokinetic force of the present invention is a reaction tank (200), which includes an operating fluid that is a beneficial mixed microbial solution composed of fermentation broth of phosphorus solubilizing bacteria, Photosynthetic Bacteria (PSB), yeast, and lactic acid bacteria (210); an electrode tank (220) of an anode tank (221) and a cathode tank (222), are respectively arranged at the corresponding two ends of a soil tank (230), and are arranged horizontally with each other, and the operating fluid (210) is introduced into it. The anode tank (221) is provided with a porous iridium titanium oxide electrode and is used as the anode. The cathode tank (222) is provided with stainless steel electrodes as the cathode, and each is electrically connected to an external DC power supply (240) to facilitate the application of an electric field; loading soil with heavy pollutants (232) into the soil tank (230) which is provided with a soil retaining net (231) at the connection between the anode tank (221) and the cathode tank (222) to prevent the soil from being introduced into the anode tank (221) and the cathode tank (222), and flow the operating fluid (210) so that the soil (232) is immersed in the operating fluid (210), and the operating fluid (210) is guided into the anode tank (221) and the cathode tank (222), its height needs to be higher than the height of the soil tank (230), so that the soil (232) is completely immersed in the operating fluid (210).

The heavy pollutant soil (232) contains heavy metals, sludge, river bottom sediment, or incinerator bottom ash composed of cadmium, copper, nickel, chromium, zinc, lead, mercury, and arsenic pollutants.

An experiment of an embodiment of the present invention collects agricultural soil that has been contaminated by cadmium. After air drying or removing water, the debris such as rocks and plants are picked out so that the soil does not have other debris. After grinding the soil with a 10-mesh screen, put it in a container and store it in a cool place.

The soil after the pretreatment is subjected to basic property analysis. The analysis and measurement of the soil pH value is 4.8, the organic matter content is 1.32%, the texture is clay loam, and the heavy metal cadmium concentration in the soil is 177.6±10.3 mg/kg.

Using a reaction tank composed of an anode tank, a soil tank, and a cathode tank, the soil is placed in the soil tank and placed on a porous soil retaining plate made of PVC material which is positioned between the soil tank, the anode tank, and the cathode tank. Fix the soil in the soil tank in combination with a non-woven filter screen, and then introduce the operating fluid with the beneficial mixed microbial solution into the soil tank with the soil to make it so the soil can be immersed in the operating fluid with the beneficial mixed microbial solution. In addition to the beneficial mixed microbial solution, the other components of the control group include water, 0.1 M citric acid, and ethylenediaminetetraacetic acid (EDTA). The pH value and conductivity of the water, 0.1 M citric acid, and EDTA are shown in Table A below:

TABLE A

| | | conductivity | surface tension |
|---|---|---|---|
| Electrolyte | pH | (mS/m) | (dyn/cm) |
| Tap water | 6.8 | 0.03 | 72.7 |
| Citric acid | 2.0 | 3.6 | 72.0 |
| Ethylenediaminetetraacetic | 4.3 | 10.1 | 73.0 |
| acid (EDTA) | | | |
| Beneficial mixed microbial | 3.8 | 7.6 | 50.3 |
| solution | | | |

From Table A above, in the control group, citric acid has the lowest pH value, while EDTA has the highest conductivity of 10.1 μS/cm, followed by the beneficial mixed microbial solution of 7.6 μS/cm, and the beneficial mixed microbial solution obviously has a lower surface tension value.

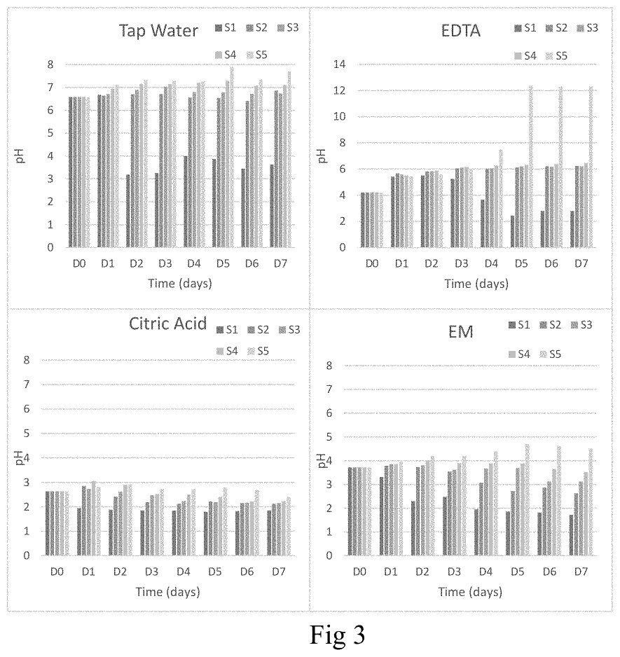

After the soil is soaked for a fixed period of time, the ideal time is about 3 days, the original operating fluid is exported to the anode tank and the cathode tank, and the liquid level of the operating fluid is higher than the soil tank and the height of the soil. A porous iridium-titanium oxide electrode as the anode is placed in the anode tank, a stainless steel electrode as the cathode in placed in the cathode tank, and an electric field of 1 V/cm is applied between the cathode and the anode, and the external electric field is switched on. Then, the soil in the soil tank is divided into five equal parts from the anode to the cathode, and the areas marked S1 to S5 are respectively taken from each aliquot of soil every day, and each aliquot of soil is analyzed to observe the daily removal efficiency of heavy metals. The collected soil is analyzed for heavy metals by microwave digestion, and then the concentration of heavy metals is measured by atomic absorption spectrometer. Please refer to FIG. 3. As the soil itself is acidic soil with a pH of 4.8, the buffering capacity of the soil is not high. In an environment with an applied voltage of 30V, compared to the control group, water is used as an operating fluid, the pH value of S1 in the area closest to the anode can be reduced to 3.6, but due to the poor conductivity of the water, it is only 0.03 mS/m, and the pH value of the area outside S1 (S2-S5) is in the tested operating fluid, because citric acid has the lowest pH, the pH value of all areas in the associated soil tank is below 3, and the pH of the area S1 closest to the anode tank can be as low as 1.85, which is effective for mixing microorganisms. The pH value of the mixed microbial solution is 3.8 higher than the pH 2.0 of citric acid by about two levels, but the conductivity of the effective mixed microbial solution is 7.6 mS/m is significantly higher than the 3.6 mS/m of citric acid. After treating the soil with the beneficial mixed microbial solution and electrokinetic method, the pH value of the area S1 closest to the anode tank is 1.72, even lower than the pH value of citric acid 1.85, while the pH value of the area S5 near the cathode tank is slightly higher 4.5. The pH value of the prepared EDTA solution is 6.3 and the highest conductivity is 10.1 mS/m. After the soil is treated by electrokinetic method combined with EDTA, the pH of the area S1 near the anode tank can drop to 2.8, while the pH value of the cathode tank area is as high as 12.3. According to the data, the higher the conductivity of the operating solution, the more the pH of the anode can drop and the more the pH of the cathode can rise.

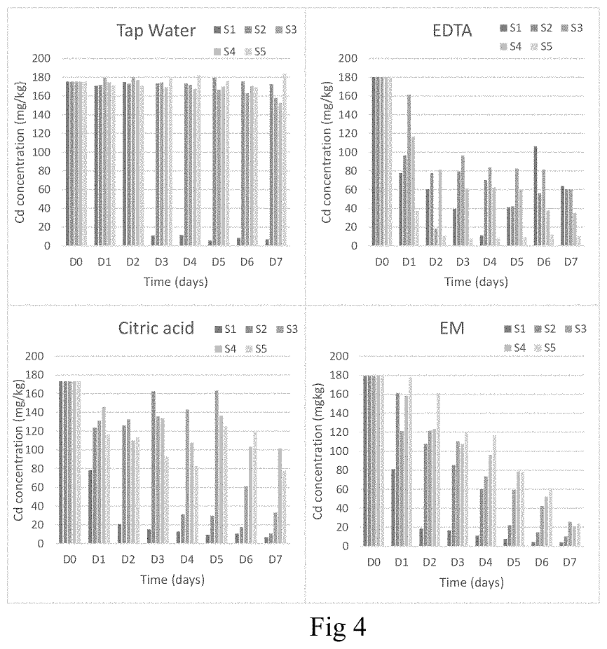

Therefore, please refer to FIG. 4, combining different operating fluids with electrokinetic method to remove heavy metal cadmium in the soil, compare the removal efficiency of citric acid and beneficial mixed microbial solution on heavy metal cadmium, although the pH value of citric acid, except for the S1 area close to the anode, is almost the same as the beneficial microbial bacterial solution. The soil treated by the beneficial mixed microbial solution in other areas (S2-S5) is significantly higher than the citric acid by about one order, but the citric acid group soil after 7 days of treatment, the cadmium concentration of the soil in the S5 zone closest to the cathode tank was 77.7 mg/kg, which is still a high heavy metal residue. The soil treated with the beneficial mixed microbial solution, the cadmium concentration of the soil in the S5 zone near the cathode tank was only 23.8 mg/kg which shows that the treatment effect of the beneficial mixed microbial solution is significantly better than that of citric acid. The combination of EDTA and electrokinetic method to remove cadmium in the soil is different from the expected effect because at the area near the cathode tank S5 the pH is higher, but the cadmium removal effect is the best near the cathode tank S5. This phenomenon is completely opposite to the result obtained by citric acid or beneficial bacteria solution that is close to the anode and has a better removal effect.

According to data, the beneficial mixed microbial solution has only 24.1% removal effect on cadmium on the first day, but the removal efficiency on the third day is 52.9%, which is better than citric acid by 50.1%. By the seventh day, the removal efficiency was as high as 90.5%, which was significantly better than other operating flow values. Therefore, the initial pH value of the beneficial mixed microbial solution is 3.6, which is higher than that of citric acid in the tested operating fluid, but since the conductivity of the beneficial mixed microbial solution is 7.0 mS/m, which is higher than the 3.0 mS/m of citric acid, under the applied electric field, more acid can be produced at the anode, so that the pH of the anode can be reduced to 1.72 on the seventh day, or even lower than 1.85 of citric acid. Conducive to the removal of heavy metal cadmium, and the high conductivity also contributes to the efficiency of electromigration, and the effect of the beneficial mixed microbial solution is almost as good as that of the heavy metal chelating agent, which helps the removal of heavy metals in the soil. This has a significant removal effect on the market for removing contaminated soil. The surface tension of beneficial mixed microorganisms is 50.3 dyn/cm, which is much smaller than that of water 72.7 dyn/cm. The lower surface tension value could help the beneficial microbial solution penetrate more deeply into the soil pore structure, and hence enhance the heavy metal removal efficiency.

TABLE B

| | Tap | Citric | EDTA | Beneficial mixed |
|---|---|---|---|---|
| time | water (%) | acid (%) | (%) | microorganisms (%) |
| D1 | 3.6 | 43.5 | 47.2 | 24.1 |
| D2 | 2.9 | 46.6 | 66.9 | 42.7 |
| D3 | 17.7 | 50.1 | 69.5 | 52.9 |
| D4 | 19.3 | 60.6 | 73.6 | 61.9 |
| D5 | 20.4 | 52.7 | 74.1 | 73.6 |
| D6 | 22.6 | 66.4 | 70.6 | 80.6 |
| D7 | 24.4 | 74.9 | 72.4 | 90.5 |

In summary, the combination of beneficial mixed microbial solution and electrokinetic method of the present invention is used to remove heavy metal from contaminated soil, which can effectively remove heavy metal substances in soil under 7 days of operating conditions, showing that the method of the present invention has a certain removal effect on the removal of soil heavy metals.

As can be seen from the above implementation description, compared with the prior art and products, the present invention has the following advantages:

1. The method and equipment of the present invention for improving the electrokinetic force to remove pollutants by using the beneficial mixed microbial solution as the electrolyte instead of a chemical acid or heavy metal chelating agent. The beneficial mixed microorganisms can avoid repeated pollution of chemical agents.

2. In the method and equipment of the present invention for improving the electrokinetic removal of pollutants by using a mixture of beneficial microorganisms with a mixture of microorganisms, the cost of the beneficial mixed microorganisms used is relatively low, and it has a better efficiency for the removal of heavy metals.

3. The method and equipment of the present invention for improving the electrokinetic removal of pollutants by using a mixture of beneficial microorganisms can not only remove heavy metals in the soil, but also can be used to remove heavy metals from sludge and incinerator bottom slag.

4. The method and equipment of the present invention for improving the electrokinetic removal of pollutants by using a mixture of beneficial microorganisms can not only remove heavy metals in the soil, but can also have the effect of decomposing organic matter, and at the same time have the effect of sludge dewatering efficacy, can effectively reduce the amount and toxicity of sludge, and has an extremely high commercial application value.

Specifically, in addition to using beneficial mixed microorganisms alone as the electrolyte solution of the electrokinetic method, the present invention can also be used in combination with other electrolyte solutions or different acid solutions to seek the maximum migration of different heavy metals by the mixed solution.

The above are only the best specific embodiments of the present invention, but the structural features of the present invention are not limited thereto. Anyone familiar with the art in the field of the present invention can easily think of changes or modifications, all can be covered in the following patent scope of this case.

In summary, the present invention does have an unprecedented innovative structure. It has not been seen in any publications, and there has not been any similar product on the market, so its novelty should be considered. In addition, the unique features and functions of the present invention are far from comparable with conventional ones, so it is indeed more progressive than conventional ones, and it meets the requirements of Patent Law concerning the requirements for application of invention patents.

What is claimed is:

1. A method of using a mixture of beneficial microorganisms to enhance electrokinetic force to remove pollutants, including:
Step 1. (S110) collect the air-dried soil, and remove debris;
Step 2. (S120) grind the soil with a retaining net of 10 meshes and put it in a container and place it in a cool place;
Step 3. (S130) utilize a reaction tank composed of an anode tank, a soil tank, and a cathode tank, put the soil on a porous soil retaining plate made of PVC material in the soil tank between the anode tank and the cathode tank and use a non-woven filter screen to fix the soil in the soil tank;
Step 4. (S140) guide operating fluid with beneficial mixed microbial solution into the soil tank with the soil, so that the soil can be immersed in the operating fluid;
Step 5. (S150) after being immersed for a fixed period of time, export the original operating fluid to the anode tank and the cathode tank, and make the liquid level of the operating fluid higher than the soil height in the soil tank;
Step 6. (S160) a porous iridium titanium oxide electrode is set as an anode in the anode tank, and a stainless steel electrode is set as a cathode in the cathode tank;
Step 7. (S170) apply an electric field of 1 V/cm to the anode and cathode respectively; and
Step 8. (S180) concentration of heavy metal components in the soil can be gradually reduced, and after 7 days of electrokinetic operation, the heavy metal components in the soil can be significantly reduced to nearly complete removal.

2. The method of using a mixture of beneficial microorganisms to enhance the electrokinetic force to remove pollutants of claim 1, wherein the beneficial mixture of microorganisms has a pH of 3.8, a conductivity of 7.6 mS/m, and a surface tension of 50.3 dyn/cm.

3. A system that uses a mixture of beneficial microorganisms to enhance electrokinetic force to remove pollutants comprises a reaction tank (200), which includes:
an operating fluid (210), which is a beneficial mixed microbial solution composed of fermentation broth with phosphorus solubilizing bacteria, photosynthetic bacteria (PSB), yeast, and lactic acid bacteria;
two electrode tanks (220) including an anode tank (221) and a cathode tank (222), are respectively arranged at the corresponding two ends of a soil tank (230) and arranged horizontally with each other and the operating fluid (210) is imported into the two electrode tanks; and
the soil tank (230) loaded with soil (232) with heavy pollutants, and a soil-retaining net (231) is respectively provided at the connection between the anode tank (221) and the cathode tank (222), the soil-retaining net (231) prevents the soil from being introduced into the anode tank (221) and the cathode tank (222), and the operating fluid (210) flows so that the soil (232) is soaked in the operating fluid (210).

4. The system for improving the electrokinetic force to remove pollutants by using the mixed microbial solution of beneficial microorganisms of claim 3, wherein the anode tank (221) and the cathode tank (222) are each connected to an external DC power supply (240).

5. The system for improving the electrokinetic force to remove pollutants by using the mixed microbial solution of beneficial microorganisms of claim 3, wherein the operating fluid (210) is introduced into the anode tank (221) and the cathode tank (222), and the height must be higher than the height of the soil tank (340), so that the soil (230) is completely immersed in the operating fluid (210).

6. The system that uses a mixture of beneficial microorganisms to enhance electrokinetic force to remove pollutants of claim 3, wherein the heavy pollutant soil (232) is composed of cadmium, copper, nickel, chromium, heavy metals composed of zinc, lead, mercury, and arsenic, sludge, river bottom sludge, or incinerator bottom ash pollutants.

7. The system for removing pollutants by using a mixture of beneficial microorganisms to enhance electrokinetic force of claim 3, wherein the anode tank (221) is provided with a porous iridium titanium oxide electrode as the anode.

8. The system for removing pollutants by using a mixture of beneficial microorganisms to enhance electrokinetic force of claim 3, wherein the cathode tank (222) is provided with a stainless steel electrode as a cathode.
